(19) United States
(12) Patent Application Publication
(10) Pub. No.: US 2026/0105778 A1
(43) Pub. Date: Apr. 16, 2026

(54) INFORMATION PROCESSING DEVICE, INFORMATION PROCESSING METHOD, AND RECORDING MEDIUM STORING PROGRAM

(71) Applicant: SHISEIDO COMPANY, LTD., Chuo-ku, Tokyo (JP)

(72) Inventors: Shoichiro TSUKAMOTO, Tokyo (JP); Tsubasa HIROTA, Tokyo (JP); Kosuke IZUMI, Tokyo (JP); Takayuki YAMANE, Tokyo (JP); Ai TAKAMURA, Tokyo (JP); Yumi UEDA, Tokyo (JP)

(73) Assignee: SHISEIDO COMPANY, LTD., Chuo-ku, Tokyo (JP)

(21) Appl. No.: 19/115,952

(22) PCT Filed: Oct. 13, 2023
(86) PCT No.: PCT/JP2023/037124

§ 371 Date: Mar. 27, 2025

(30) Foreign Application Priority Data
Oct. 27, 2022 (JP) 2022-172617

(51) Int. Cl. G06V 40/16; G06V 10/75; G06V 10/764; G06V 20/40

(52) U.S. Cl. CPC G06V 40/174; G06V 10/75; G06V 10/764; G06V 20/40

(57) ABSTRACT

An information processing apparatus 2 includes: a video acquisition part 231 that acquires a video in which the face of a user is captured; a detection part 232 that detects, on the basis of the video acquired by the video acquisition part 231, one or more expression patterns of the user, and an expression intensity indicating the degree of intensity of the expression for each of the one or more expression patterns; and an output part 235 that outputs beautifying information relating to the beauty of the user's face on the basis of the detection results by the detection part 232. The information processing apparatus 2 further includes an estimation part 234 that estimates the occurrence risk of wrinkles occurring on the user's face on the basis of the occurrence frequency and the facial expression intensity of each of the one or more expression patterns detected by the detection part 232. The output part 235 outputs beautifying information that corresponds to the occurrence risk estimated by the estimation part 234.

### CROSS-REFERENCE TO RELATED APPLICATIONS

The present application is a U.S. National Stage entry of PCT Application number PCT/JP2023/037124, filed on Oct. 13, 2023, which claims priority under 35 U.S.C § 119(a) to Japanese Patent Application No. 2022-172617, filed on Oct. 27, 2022, contents of which are incorporated herein by reference in their entirety.

### BACKGROUND OF THE INVENTION

The present disclosure relates to an information processing apparatus, an information processing method, and a recording medium storing a program.

Conventionally, a system for providing information for a cosmetic appearance of a user's face is known. Japanese Unexamined Patent Application Publication No. 2018-160230 discloses a technique for providing information corresponding to a user's skin type identified on the basis of an image of a user's skin.

However, the above-described technique has a problem in that it can only provide information corresponding to the current condition of a user's skin.

The present disclosure focuses on this point, and an object thereof is to provide information that takes into account potential future changes in a user's skin.

### BRIEF SUMMARY OF THE INVENTION

An information processing apparatus of a first aspect of the present disclosure includes a video acquisition part that acquires a video obtained by capturing a face of a user, a detection part that detects i) one or more facial expression patterns of the user and ii) respective facial expression intensities, representing a degree of intensity of facial expression, of the one or more facial expression patterns, on the basis of the video acquired by the video acquisition part, and an output part that outputs cosmetic information for a cosmetic appearance of the face of the user on the basis of a detection result from the detection part.

An information processing method of a second aspect of the present disclosure is an information processing method executed by a computer, the method includes the steps of acquiring a video obtained by capturing a face of a user, detecting i) one or more facial expression patterns of the user and ii) respective facial expression intensities, representing a degree of intensity of facial expression, of the one or more facial expression patterns, on the basis of the video acquired by the video acquisition part, and outputting cosmetic information for a cosmetic appearance of the face of the user on the basis of a detection result from the detection part.

A non-transitory computer-readable recording medium storing a program of a third aspect of the present disclosure causes a computer to acquire a video obtained by capturing a face of a user, detect i) one or more facial expression patterns of the user and ii) respective facial expression intensities, representing a degree of intensity of facial expression, of the one or more facial expression patterns, on the basis of the acquired video, and output cosmetic information for a cosmetic appearance of the face of the user on the basis of a detection result from the detection part.

### BRIEF DESCRIPTION OF THE DRAWINGS

FIG. 1 illustrates an overview of an information processing system.

FIGS. 2A and 2B illustrate the overview of the information processing system.

FIG. 3 shows a configuration of an information processing apparatus.

FIG. 4 shows an example of a configuration of a correspondence table.

FIG. 5 shows an example of a configuration of a cosmetic management database.

FIG. 6 schematically shows a detection result by a detection part.

FIG. 7 schematically shows a display screen on which cosmetic information is displayed.

FIG. 8 is a flowchart that shows processing of the information processing apparatus.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Overview of Information Processing System S

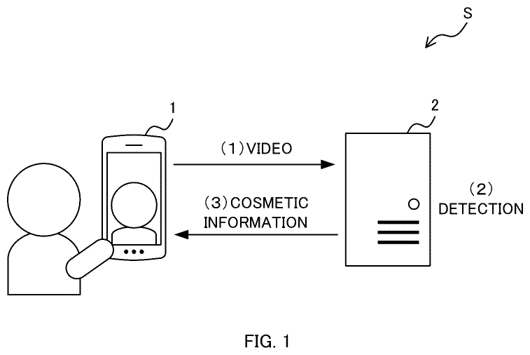

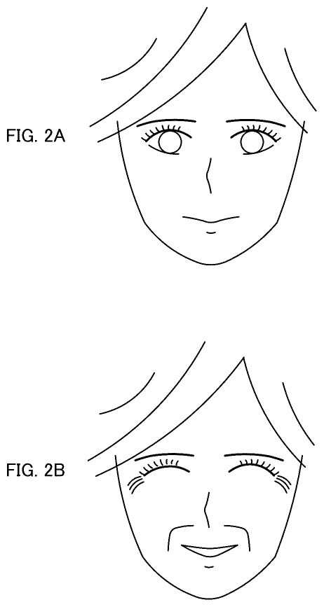

FIGS. 1 and 2 illustrate an overview of an information processing system S. The information processing system S is a system used to provide an information processing service to a user. The information processing service is a service that provides cosmetic information to a user. The cosmetic information pertains to a cosmetic appearance of a user's face, and includes a cosmetic product (for example, cosmetics, a cosmetic device, food, or the like), cosmetology, and the like, for example.

The user makes various facial expressions corresponding to changes in emotion. In general, each user has a facial expression in a specific pattern corresponding to each emotion, and when expressing an emotion on their face, the user adopts a facial expression in a specific pattern corresponding to that emotion. When the user makes a facial expression in a pattern corresponding to a certain emotion, lines (wrinkles) are formed on the user's skin due to a habitual nature of that facial expression, and when the user returns to a neutral facial expression, the wrinkles caused by the habitual nature of that facial expression disappear. However, if the user repeatedly makes a facial expression in a same pattern, some of the wrinkles temporarily formed on the user's skin caused by the habitual facial expression may remain even after returning to the neutral facial expression, and these remaining wrinkles may become permanent.

FIG. 2A shows a normal facial expression of a user (for example, a neutral facial expression), and FIG. 2B shows a facial expression of the user when smiling. Although the user's face has no wrinkles in the normal facial expression shown in FIG. 2A, if the user repeatedly makes the facial expression shown in FIG. 2B each time they smile, crow's feet wrinkles and nasolabial fold wrinkles may fail to disappear in the future, potentially becoming permanent. Additionally, on the user's face, as the intensity of the facial expression shown in FIG. 2B increases, crow's feet wrinkles and nasolabial fold wrinkles may deepen, making them more likely to become permanent. It should be noted that the user may not only consciously make a certain facial expression as described above but also unconsciously make a certain facial expression, and a repeated unconscious facial expression may lead to formation of permanent wrinkles on the user's face. Therefore, the information processing service is desired to provide the user with cosmetic information that takes into account potential future changes in the user's skin, such as wrinkles.

Accordingly, the information processing system S provides the user with the cosmetic information that takes into account potential future changes in the user's face. The information processing system S shown in FIG. 1 includes a user terminal 1 and an information processing apparatus 2.

The user terminal 1 is a terminal used by the user, and is a smartphone, a tablet terminal, or a personal computer, for example. The user terminal 1 includes an operation part such as a touch panel or a keyboard for receiving a user operation, a display unit such as a liquid crystal display for displaying information, an imaging unit such as a camera for capturing an image, a sound output unit such as a speaker for outputting sound, and a sound input unit such as a microphone for collecting sound. The user terminal 1 can communicate with the information processing apparatus 2 via a network.

The information processing apparatus 2 is an apparatus that manages the information processing service, and is a server, for example. The information processing apparatus 2 can communicate with the user terminal 1 via a network.

The processing executed by the information processing system S to provide information for maintaining or improving the cosmetic appearance of the user's face will be described with reference to FIG. 1 below.

First, when the user captures a video of the user's face with the user terminal 1, the user terminal 1 transmits the captured video to the information processing apparatus 2 ((1) in FIG. 1). The information processing apparatus 2 detects i) one or more facial expression patterns of the user and ii) respective facial expression intensities of those one or more facial expression patterns, on the basis of the video acquired from the user terminal 1 ((2) in FIG. 1).

The facial expression patterns include, for example, “raising the inner parts of the eyebrows” or “lifting the cheeks,” with various expression patterns being predefined. The facial expression patterns are, for example, Action Units (AUs) defined in the Facial Action Coding System (FACS). The facial expression intensity represents the degree of intensity of the facial expression and is quantified as a numerical value indicating the extent to which the user's facial expression shifts from a neutral facial expression to a specific facial expression pattern, for instance.

Then, the information processing apparatus 2 transmits the cosmetic information to the user terminal 1 on the basis of a detection result ((3) in FIG. 1). Thereafter, the user terminal 1 displays the cosmetic information for the display unit.

In this way, the information processing system S can provide information that takes into account potential future changes in the user's skin caused by conscious or unconscious facial expressions. For example, on the basis of the provided information, the user may delay the progression of changes in their skin condition or prolong the period during which their current skin condition is preserved. Additionally, the information processing system S may notify the user of the habitual facial expression as the information that takes into account potential future changes in the user's skin, which enables the user to anticipate wrinkles that may form in the future (potential future wrinkles that may become permanent on the user's skin).

A configuration of the information processing apparatus 2 will be described below.

### Configuration of Information Processing Apparatus 2

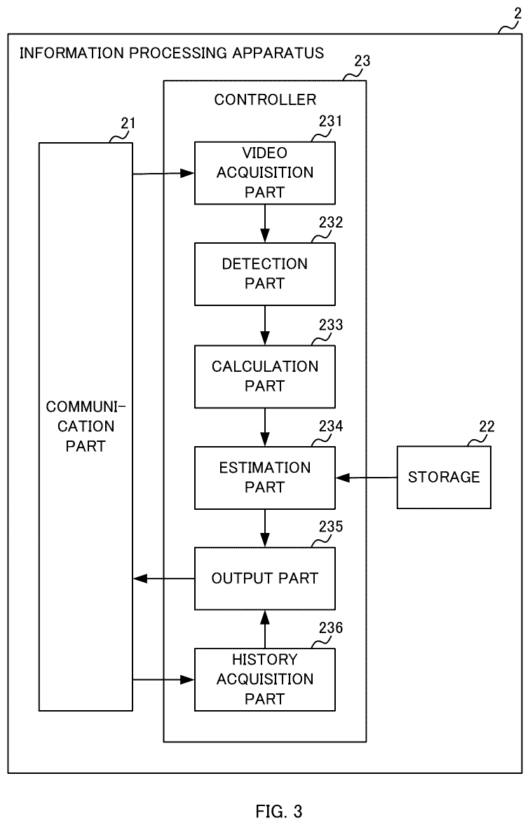

FIG. 3 shows the configuration of the information processing apparatus 2. The information processing apparatus 2 includes a communication part 21, a storage 22, and a controller 23. The controller 23 includes a video acquisition part 231, a detection part 232, a calculation part 233, an estimation part 234, an output part 235, and a history acquisition part 236.

The communication part 21 is an interface for connecting to a network, and includes a communication controller, for example. The storage 22 is a storage medium such as a Read Only Memory (ROM), a Random Access Memory (RAM), and a hard disk. The storage 22 stores a program executed by the controller 23.

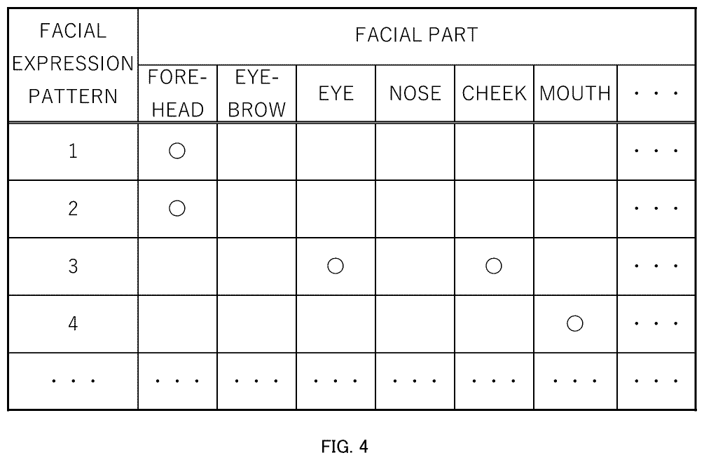

The storage 22 stores a correspondence table in which facial expression patterns and facial parts are associated with each other. FIG. 4 shows an example of a configuration of the correspondence table. In the example shown in FIG. 4, the facial expression pattern is associated with whether or not it corresponds to various facial parts (such as forehead, eyebrows, eyes, nose, and mouth). For example, a facial expression pattern “1” is associated with the “forehead” among a plurality of facial parts.

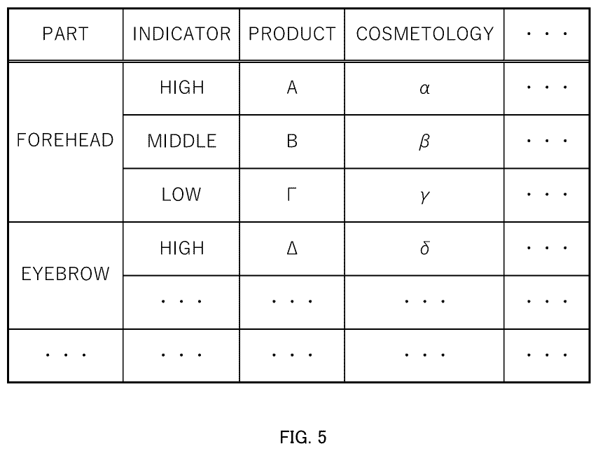

Further, the storage 22 stores a cosmetic management database that manages information for a cosmetic appearance to be recommended to the user. FIG. 5 shows an example of a configuration of the cosmetic management database. In the example shown in FIG. 5, the cosmetic management database stores a facial part, an indicator, a product, and cosmetology in association with each other.

The indicator is a numerical value indicating a risk of wrinkles forming on or around the user's facial part (hereinafter referred to as “wrinkle formation risk”). The product is an item recommended to the user to reduce the wrinkle formation risk for a specific facial part, on the basis of the degree of such risk. The product includes at least one of cosmetics, a cosmetic device, or food, for example. The cosmetology refers to a method such as massage recommended to the user to reduce the wrinkle formation risk for a specific facial part, on the basis of the degree of such risk. The cosmetology includes at least one of an image or video demonstrating a method such as massage that the user can perform themselves or information indicating an establishment, such as a beauty salon, that offers massage and similar services, for example.

Returning to FIG. 3, the controller 23 is a Central Processing Unit (CPU), for example. The controller 23 functions as the video acquisition part 231, the detection part 232, the calculation part 233, the estimation part 234, the output part 235, and the history acquisition part 236 by executing the program stored in the storage 22.

The video acquisition part 231 acquires a video recording the user's face from the user terminal 1. The video acquisition part 231 may further acquire identification information (identifier: ID) for identifying the user.

The video acquisition part 231 acquires a video captured while the user is speaking, for example. Specifically, the output part 235 first outputs a question to the user before the video acquisition part 231 acquires the video. Then, the video acquisition part 231 acquires the video after the output part 235 outputs the question to the user.

For example, when the user accesses a website of the information processing service using the user terminal 1, the output part 235 causes the user terminal 1 to display a display screen of the information processing service. An imaging button for causing an imaging unit of the user terminal 1 to capture a video is provided on the display screen, and when the user presses the imaging button on the display screen displayed on the user terminal 1, the imaging unit of the user terminal 1 starts capturing a video.

When the imaging button is pressed, the output part 235 causes the user terminal 1 to output a predetermined question to the user by voice. For example, the imaging unit of the user terminal 1 captures a video of the facial expression of the user when listening to the question, the facial expression of the user when answering the question, and the like until a predetermined period (for example, several minutes) elapses after the imaging button is pressed. When the predetermined period elapses after the imaging button is pressed, the user terminal 1 transmits the captured video to the information processing apparatus 2. Thus, the information processing apparatus 2 can capture a change in the user's face.

As described above, the display screen of the information processing service may be a display screen that is displayed in response to accessing a website, but it is not limited thereto. For instance, the display screen of the information processing service may be a display screen displayed in response to activation of a dedicated application program (hereinafter referred to as a “dedicated app”) for providing the information processing service. For example, the user terminal 1 may have the dedicated app installed, and when the user operates the user terminal 1 to activate the dedicated app, the user terminal 1 may display the display screen of the information processing service on the display unit.

The detection part 232 detects i) one or more facial expression patterns of the user and ii) respective facial expression intensities of the one or more facial expression patterns, on the basis of the video acquired by the video acquisition part 231. Specifically, the detection part 232 detects i) one or more facial expression patterns and ii) respective facial expression intensities of those one or more facial expression patterns at predetermined intervals in the video acquired by the video acquisition part 231.

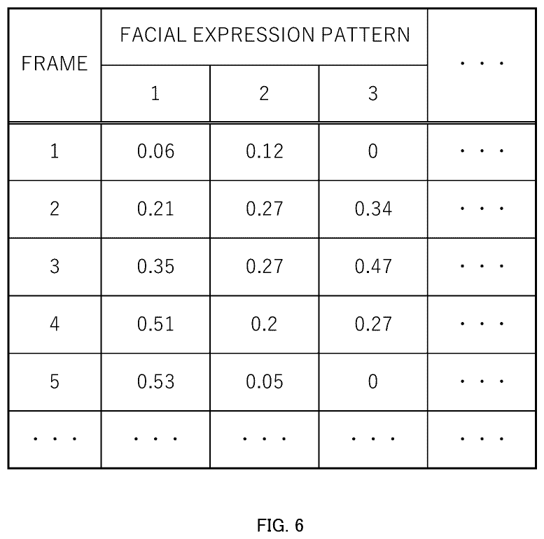

FIG. 6 schematically shows a detection result by the detection part 232. In the example shown in FIG. 6, numerical values indicating respective facial expression intensities of a plurality of facial expression patterns are provided for each frame of the video. For example, if a certain facial expression pattern is detected, the facial expression intensity is quantified as a numerical value greater than 0, and if a certain facial expression pattern is not detected, the facial expression intensity is quantified as 0. In this way, the detection part 232 detects the respective facial expression intensities of the plurality of facial expression patterns for each frame of the video.

The detection part 232 may detect the facial expression pattern of the user and the facial expression intensity of that facial expression pattern by using an external service. For example, the external service is a service that analyzes the user's face appearing in the video and provides a detection result of detecting the respective facial expression intensities of the plurality of facial expression patterns at predetermined intervals (for example, each frame of the video). In this case, the detection part 232 transmits the video to the external service and acquires the detection result outputted by that external service.

The output part 235 outputs the cosmetic information for the cosmetic appearance of the user's face on the basis of the detection result from the detection part 232. Specifically, the output part 235 causes the user terminal 1 to display the cosmetic information by transmitting the cosmetic information to the user terminal 1. For example, the information processing apparatus 2 may further include a display unit (not shown in figures) and the output part 235 may cause that display unit to display the cosmetic information.

The output part 235 outputs, as the cosmetic information, at least one of information indicating a product or information indicating the cosmetology. The output part 235 outputs the cosmetic information corresponding to the wrinkle formation risk based on the detection result from the detection part 232, for example. Specifically, the information processing apparatus 2 executes the following two steps to output the cosmetic information corresponding to the wrinkle formation risk.

As a first step, the estimation part 234 estimates the risk of future changes in the user's skin on the basis of the detection result from the detection part 232. Specifically, the estimation part 234 estimates the wrinkle formation risk on the basis of i) respective occurrence frequencies of the one or more facial expression patterns detected by the detection part 232 and ii) the respective facial expression intensities of the one or more facial expression patterns detected by the detection part 232.

More specifically, the estimation part 234 estimates the wrinkle formation risk by classifying the wrinkle formation risk into an indicator on the basis of i) the respective occurrence frequencies of the one or more facial expression patterns detected by the detection part 232 and ii) the respective facial expression intensities of the one or more facial expression patterns detected by the detection part 232.

For example, the indicator indicating the wrinkle formation risk includes “low” and “high.” In this case, the estimation part 234 classifies the wrinkle formation risk as the indicator “low” when the occurrence frequency of the facial expression pattern is lower or when the facial expression intensity of that facial expression pattern is weaker (that is, when the numerical value indicating the facial expression intensity is smaller). In addition, the estimation part 234 classifies the wrinkle formation risk as the indicator “high” when the occurrence frequency of the facial expression pattern is greater or when the facial expression intensity of that facial expression pattern is greater (that is, when the numerical value indicating the facial expression intensity is greater).

The estimation part 234 may estimate the wrinkle formation risk using a predetermined threshold value. Specifically, the calculation part 233 first calculates the sum total of the facial expression intensities detected by the detection part 232 at predetermined intervals. The calculation part 233 calculates the sum total of the respective facial expression intensities of the facial expression patterns detected by the detection part 232 for each frame of the video, for example.

The estimation part 234 estimates the wrinkle formation risk on the basis of i) the sum total of the facial expression intensities calculated by the calculation part 233 (hereinafter referred to as a “sum total value”) and ii) a threshold sum total value which is a predetermined threshold value. For example, the estimation part 234 classifies the wrinkle formation risk as the indicator “low” if the sum total value is less than the threshold sum total value, and classifies the wrinkle formation risk as the indicator “high” if the sum total value is equal to or greater than the threshold sum total value.

The estimation part 234 may estimate the wrinkle formation risk using a plurality of threshold sum total values. For example, the information processing apparatus 2 defines the plurality of threshold sum total values (for example, two threshold values that are i) a first threshold sum total value and ii) a second threshold sum total value larger than the first threshold sum total value) for classifying the risk into one of “low,” “medium,” and “high” included in the indicator.

In this case, if the sum total value is less than the first threshold sum total value, the estimation part 234 classifies the wrinkle formation risk as the indicator “low.” Further, if the sum total value is equal to or larger than the first threshold sum total value and less than the second threshold sum total value, the estimation part 234 classifies the wrinkle formation risk as the indicator “medium.” Furthermore, if the sum total value is equal to or larger than the second threshold sum total value, the estimation part 234 classifies the wrinkle formation risk as the indicator “high.”

As a second step, the output part 235 outputs the cosmetic information corresponding to the wrinkle formation risk estimated by the estimation part 234. Specifically, the output part 235 outputs, as the cosmetic information corresponding to the estimated wrinkle formation risk, at least one of i) information indicating a product for addressing the wrinkle formation risk of the user's face or ii) information indicating the cosmetology for addressing the wrinkle formation risk of the user's face.

For example, if the wrinkle formation risk is classified as the indicator “high,” the output part 235 outputs information of at least one of the product or the cosmetology associated with the indicator “high” in the cosmetic management database. In this way, the information processing apparatus 2 can provide information for delaying progression of future wrinkle formation in the user's face.

The output part 235 may output cosmetic information corresponding to at least one of the plurality of facial parts. For example, the information processing apparatus 2 defines a threshold sum total value for each facial part. In this case, the calculation part 233 first refers to the correspondence table stored in the storage 22 and calculates, for each facial part, the sum total of the respective facial expression intensities of the one or more facial expression patterns, detected by the detection part 232 and associated with those parts. For example, if the correspondence table associates the facial part “forehead” with facial expression patterns “1” and “2,” the calculation part 233 calculates the sum total of facial expression intensities of the facial part “forehead” by summing the numerical values indicating the facial expression intensities of the facial expression patterns “1” and “2,” which are detected by the detection part 232 at predetermined intervals.

The estimation part 234 estimates the wrinkle formation risk for each facial part on the basis of i) one or more threshold sum total values corresponding to that part and ii) the sum total value corresponding to that part. The output part 235 then outputs the cosmetic information corresponding to at least one of the plurality of facial parts on the basis of the wrinkle formation risk corresponding to each part.

The output part 235 outputs the cosmetic information corresponding to each of the plurality of facial parts, for example. The output part 235 may output the cosmetic information corresponding to a facial part with relatively high wrinkle formation risk among the plurality of facial parts. For example, the output part 235 outputs the cosmetic information corresponding to a facial part whose indicator is equal to or greater than a threshold indicator (for example, the indicator “medium”) among the indicators respectively corresponding to the plurality of facial parts, as a part with relatively high wrinkle formation risk. The output part 235 may output the cosmetic information corresponding to a facial part with highest wrinkle formation risk (for example, the indicator “high”) among the indicators respectively corresponding to the plurality of facial parts, as a part with relatively high wrinkle formation risk. In this way, the information processing apparatus 2 can provide information for delaying progression of future wrinkle formation in a facial part with high wrinkle formation risk.

As described above, an example in which the output part 235 outputs either information indicating a product or information indicating cosmetology as cosmetic information has been explained, but the present disclosure is not limited thereto. For example, the output part 235 may output the indicator resulting from the classification by the estimation part 234 as the cosmetic information.

The output part 235 may output the indicators for all facial parts or only for some of the facial parts. In this way, the information processing apparatus 2 can enable the user to recognize the level of the risk of future wrinkle formation of the user's face.

The output part 235 may output, as the cosmetic information, at least one of i) a video scene (frame) corresponding to an instance where a facial expression pattern with relatively high occurrence frequency is detected or ii) a video scene corresponding to an instance where a facial expression pattern with relatively high facial expression intensity is detected. Specifically, the output part 235 outputs, as the cosmetic information, at least one of i) a video scene corresponding to an instance where a facial expression pattern whose occurrence frequency is equal to or higher than a predetermined threshold frequency, among the one or more facial expression patterns detected by the detection part 232, is detected or ii) a video scene corresponding to an instance where a facial expression pattern whose facial expression intensity is equal to or greater than a predetermined threshold intensity, among the one or more facial expression patterns detected by the detection part 232, is detected.

The output part 235 may output, as the cosmetic information, at least one of i) a video scene corresponding to an instance where a facial expression pattern with relatively high occurrence frequency (for example, a facial expression pattern with the highest occurrence frequency), among the one or more facial expression patterns detected by the detection part 232, is detected or ii) a video scene corresponding to an instance where a facial expression pattern with relatively high facial expression intensity (for example, a facial expression pattern with the highest facial expression intensity), among the one or more expression patterns detected by the detection part 232, is detected. In this way, the information processing apparatus 2 can enable the user to recognize the user's habitual facial expression. In this way, the user can recognize what facial expression makes the wrinkle formation risk greater. In addition, the user can anticipate wrinkles that may form in the future on the basis of the user's habitual facial expression.

The output part 235 may output a result of comparing the currently estimated wrinkle formation risk and the previously estimated wrinkle formation risk, as the cosmetic information. Specifically, the output part 235 outputs, as the cosmetic information, a comparison result obtained by comparing wrinkle formation risk estimated on the basis of a first video (hereinafter, referred to as a “first wrinkle formation risk”) and wrinkle formation risk estimated on the basis of a second video (hereinafter, referred to as a “second wrinkle formation risk”). The first video is a video captured during the current imaging session. The second video is a video captured during the previous imaging session, specifically, a video captured prior to the capturing of the first video.

For example, the storage 22 associates and stores i) the ID of the user and ii) information indicating the second wrinkle formation risk estimated by the estimation part 234 on the basis of the second video of that user in the past. In this case, the output part 235 outputs a comparison result obtained by comparing the first wrinkle formation risk estimated on the basis of the first video of the user acquired by the video acquisition part 231 with the second wrinkle formation risk stored in the storage 22 in association with the ID of that user. For example, if the indicator of the first wrinkle formation risk is “medium” and the indicator of the second wrinkle formation risk is “high,” the output part 235 outputs a message indicating that the wrinkle formation risk is reduced as the comparison result. In this way, the information processing apparatus 2 can cause the user who repeatedly uses the information processing service to recognize whether or not the wrinkle formation risk is reduced.

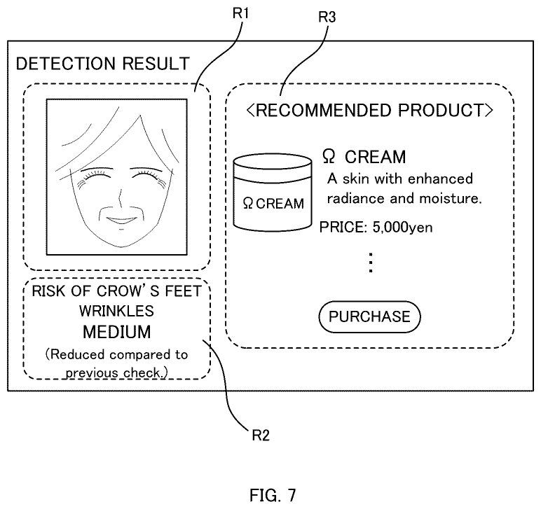

FIG. 7 schematically shows a display screen on which the cosmetic information is displayed. In FIG. 7, the cosmetic information is displayed in each of a plurality of display areas (R1, R2, and R3). A predetermined scene (a video scene corresponding to an instance where a facial expression pattern with relatively high occurrence frequency is detected, or a video scene corresponding to an instance where a facial expression pattern with relatively high facial expression intensity is detected) of the video is displayed in the display area R1. In the display area R2, an indicator indicating a wrinkle formation risk around the facial part “eye” and a message indicating a comparison result of the first wrinkle formation risk and the second wrinkle formation risk are displayed. In the display area R3, information indicating cosmetics for addressing the wrinkle formation risk around the facial part “eye” is displayed. For example, the user can purchase the cosmetics displayed in the display area R3 by pressing a “purchase” button on a cosmetic information display screen displayed on the user terminal 1.

The information processing apparatus 2 may prompt the user to use the information processing service again after a certain period has elapsed since the user purchased the product shown by the cosmetic information provided in response to the use of the information processing service. Specifically, the history acquisition part 236 first acquires a purchase history of products by the user. The purchase history refers to a record of products purchased by the user via the information processing service, for example, and associates each purchased product with its purchase date. The purchase history may be stored in the storage 22 or may be managed by an external server.

The output part 235 then refers to the purchase history, and outputs information for requesting transmission of a video after a predetermined period (for example, one month) has elapsed since the date on which the user purchased the product. In this way, the information processing apparatus 2 can diagnose whether or not the wrinkle formation risk is reduced.

The information processing apparatus 2 may prompt the user to use the information processing service again after a certain period has elapsed since the user experienced the cosmetology shown by the cosmetic information provided in response to the user's use of the information processing service. Specifically, the history acquisition part 236 first acquires a history of experiencing the cosmetology of the user. The history of experiencing the cosmetology includes, for example, a browsing history of an image introducing a method such as massage, a viewing history of a video introducing a method such as massage, or a usage history of an establishment such as a beauty salon that offers massage and similar services, and the experienced cosmetology is associated with a date on which the cosmetology was experienced.

Then, the output part 235 refers to the history of experiencing the cosmetology and outputs information for requesting transmission of a video after a predetermined period has elapsed since the date on which the user experienced the cosmetology. In this way, the information processing apparatus 2 can diagnose whether or not the wrinkle formation risk is reduced.

### Processing of Information Processing Apparatus 2

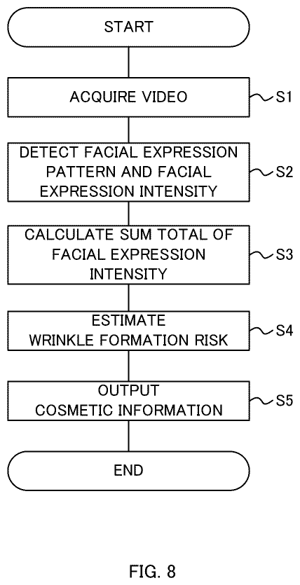

Next, processing of the information processing apparatus 2 will be described. FIG. 8 is a flowchart that shows the processing of the information processing apparatus 2. This flowchart starts when the video acquisition part 231 acquires the video from the user terminal 1 (S1).

The detection part 232 detects i) the one or more facial expression patterns and ii) the respective facial expression intensities of those one or more patterns at predetermined intervals in the video acquired by the video acquisition part 231 (S2). The calculation part 233 calculates the sum total of the facial expression intensities detected by the detection part 232 at predetermined intervals (S3).

The estimation part 234 estimates the wrinkle formation risk on the basis of i) the sum total value (the sum total of the facial expression intensities calculated by the calculation part 233) and ii) the threshold sum total value (S4). Then, the output part 235 outputs the cosmetic information corresponding to the wrinkle formation risk estimated by the estimation part 234 (S5).

### Effects of the Present Embodiment

As described above, the information processing apparatus 2 detects i) the one or more facial expression patterns of the user and ii) the respective facial expression intensities of the one or more facial expression patterns on the basis of the video of the user, and outputs the cosmetic information on the basis of the detected detection result. In this way, the information processing apparatus 2 can provide the information that takes into account potential future changes in the user's skin, such as wrinkles, caused by conscious or unconscious facial expressions.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. An information processing apparatus comprising:
a video acquisition part that acquires a video obtained by capturing a face of a user;
a detection part that detects i) one or more facial expression patterns of the user and ii) respective facial expression intensities, representing a degree of intensity of facial expression, of the one or more facial expression patterns, on the basis of the video acquired by the video acquisition part; and
an output part that outputs cosmetic information for a cosmetic appearance of the face of the user on the basis of a detection result from the detection part.

2. The information processing apparatus according to claim 1, further comprising:
an estimation part that estimates formation risk representing a risk of formation of wrinkles on the face of the user, on the basis of i) respective occurrence frequencies of the one or more facial expression patterns detected by the detection part and ii) the facial expression intensity, wherein
the output part outputs the cosmetic information corresponding to the formation risk estimated by the estimation part.

3. The information processing apparatus according to claim 1, wherein
the detection part detects the facial expression pattern and the facial expression intensity at predetermined intervals, wherein
the information processing apparatus further comprises:
a calculation part that calculates a sum total of the facial expression intensities detected at predetermined intervals; and
an estimation part that estimates the formation risk representing a risk of formation of wrinkles on the face of the user, on the basis of a predetermined threshold value and the sum total.

4. The information processing apparatus according to claim 3, further comprising:
a storage that associates and stores one or more facial expression patterns with each facial part, wherein
the calculation part calculates, for the each facial part, a sum total of the facial expression intensities of the one or more expression patterns, detected by the detection part and associated with those parts, and
the estimation part estimates, for the each facial part, the formation risk on the basis of i) the threshold value corresponding to the part and ii) the sum total corresponding to the part.

5. The information processing apparatus according to claim 1, wherein
the output part outputs, as the cosmetic information, an indicator indicating the formation risk representing a risk of formation of wrinkles on the face of the user.

6. The information processing apparatus according to claim 1, wherein
the output part outputs, as the cosmetic information, information indicating a product for addressing the formation risk representing a risk of formation of wrinkles on the face of the user.

7. The information processing apparatus according to claim 6, wherein
the product is at least one of cosmetics, a cosmetic device, or food.

8. The information processing apparatus according to claim 6, further comprising:
a history acquisition part that acquires a purchase history of the product by the user, wherein
the output part refers to the purchase history and outputs information for requesting transmission of the video after a predetermined period has elapsed since a date on which the user purchased the product.

9. The information processing apparatus according to claim 1, wherein
the output part outputs, as the cosmetic information, information indicating cosmetology for addressing the formation risk representing a risk of formation of wrinkles on the face of the user.

10. The information processing apparatus of claim 9, further comprising:
a history acquisition part that acquires a history of experiencing the cosmetology by the user, and
the output part refers to the history of experiencing the cosmetology, and outputs information for requesting transmission of the video after a predetermined period of time has elapsed since a date on which the user experienced the cosmetology.

11. The information processing apparatus of claim 1, wherein
the output part outputs, as the cosmetic information, at least one of i) a scene of the video corresponding to an instance where a facial expression pattern with occurrence frequency equal to or higher than a predetermined threshold, among the one or more expression patterns detected by the detection part, is detected or ii) a scene of the video corresponding to an instance where a facial expression pattern with facial expression intensity equal to or greater than a predetermined threshold, among the one or more expression patterns detected by the detection part, is detected.

12. The information processing apparatus according to claim 1, wherein
the output part outputs, as the cosmetic information, a result of comparing i) the formation risk representing a risk of formation of wrinkles on the face of the user estimated on the basis of a first video, which is the video and ii) the formation risk representing a risk of formation of wrinkles on a face of the user estimated on the basis of a second video, which is captured prior to imaging the first video.

13. The information processing apparatus according to claim 1, wherein
the output part outputs a question to the user before the video acquisition part acquires the video, and
the video acquisition part acquires the video after the output part outputs the question to the user.

14. An information processing method executed by a computer, the method comprising the steps of:
acquiring a video obtained by capturing a face of a user;
detecting i) one or more facial expression patterns of the user and ii) respective facial expression intensities, representing a degree of intensity of facial expression, of the one or more facial expression patterns, on the basis of the video acquired by the video acquisition part; and
outputting cosmetic information for a cosmetic appearance of the face of the user on the basis of a detection result from the detection part.

15. A program for causing a computer to function as:
a video acquisition part that acquires a video obtained by capturing a face of a user;
a detection part that detects i) one or more facial expression patterns of the user and ii) respective facial expression intensities, representing a degree of intensity of facial expression, of the one or more facial expression patterns, on the basis of the video acquired by the video acquisition part; and
an output part that outputs cosmetic information for a cosmetic appearance of the face of the user on the basis of a detection result from the detection part.

16. The information processing apparatus according to claim 7, further comprising:
a history acquisition part that acquires a purchase history of the product by the user, wherein
the output part refers to the purchase history and outputs information for requesting transmission of the video after a predetermined period has elapsed since a date on which the user purchased the product.

17. The information processing apparatus according to claim 1, wherein
the output part outputs a question to the user by voice before the video acquisition part acquires the video, and
the video acquisition part acquires the video of a facial expression of the user when listening to the question and a facial expression of the user when answering the question orally.

18. The information processing apparatus according to claim 1, further comprising:
an estimation part that classifies the formation risk representing a risk of formation of wrinkles on the face of the user, estimated on the basis of the video, into an indicator, indicating a level of the formation risk, on the basis of i) respective occurrence frequencies of the one or more facial expression patterns detected by the detection part and ii) the facial expression intensity, wherein
the output part outputs, as the cosmetic information, an indicator classified by the estimation part.
